(19) United States
(12) Patent Application Publication
(10) Pub. No.: US 2026/0244525 A1
(43) Pub. Date: Aug. 20, 2026

(54) CAUSE INFERENCE DEVICE AND CAUSE INFERENCE METHOD

(71) Applicant: ASTEMO, LTD., Tokyo (JP)

(72) Inventors: Hiroki ITO, Tokyo (JP); Yoshitaka ATARASHI, Hitachinaka-shi, Ibaraki (JP); Yusuke NISHI, Hitachinaka-shi, Ibaraki (JP); Trongmun JIRALERSPONG, Hitachinaka-shi, Ibaraki (JP)

(73) Assignee: ASTEMO, LTD., Tokyo (JP)

(21) Appl. No.: 19/164,852

(22) PCT Filed: Mar. 1, 2024
(86) PCT No.: PCT/JP2024/007853

§ 371 Date: Sep. 12, 2025

(30) Foreign Application Priority Data
Apr. 25, 2023 (JP) 2023-071434

(51) Int. Cl. G06F 11/07

(52) U.S. Cl. CPC G06F 11/079; G06F 11/0709

(57) ABSTRACT

There is provided a cause inference device that estimates a failure cause of construction of a system that constructs infrastructure resource in a predetermined execution environment, the cause inference device is configured with a computer including an arithmetic device and a storage device, wherein the cause inference device includes: a cause table creation unit configured to create a cause table in which an error at the time of construction is recorded in association with the infrastructure resource, a constraint in the construction of the infrastructure resource, and a cause of the error by using construction information of the system and information of an execution environment assumed by the construction information of the system; and a cause inference unit configured to specify a cause of an error that occurs at the time of constructing the infrastructure resource with reference to the cause table.

### INCORPORATION BY REFERENCE

The present application claims priority from Japanese patent application JP 2023-71434 filed on Apr. 25, 2023, the content of which is hereby incorporated by reference into this application.

### TECHNICAL FIELD

The present invention relates to a cause inference device that estimates a cause of a system construction failure.

### BACKGROUND ART

In recent years, with development of cloud computing technologies, virtualization of IT (Information Technology) resources has progressed. With development of such a technology, an automatic system construction technology utilizing a virtualization technology such as a virtual server and a container and an IaC (Infrastructure as Code) for deploying a system based on a source code, a setting file, and the like has attracted attention.

Background art of the present technical field includes the following prior art. PTL 1 (JP2021-157612A) discloses an information processing system including a conversion unit that converts a sheet in which a system requirement and an application requirement of a cloud service are described into codes that can be interpreted by a computer, a storage control unit that stores the codes in a storage unit, and a determination control unit that performs control to deploy a resource on a cloud based on the codes, execute a test on the resource, and determine availability of the resource.

PTL 2 (JP2003-150407A) discloses an automatic recovery system that includes a monitoring device and a recovery instruction device and recovers a failure occurring in a monitoring target device, in which the monitoring device includes reception means for receiving electronic information notifying an occurrence of the failure from the monitoring target device and storage means for storing the received electronic information, and the recovery instruction device includes analysis means for referring to the storage means of the monitoring device and analyzing a cause of the failure occurring in the monitoring target device, generation means for generating electronic information for recovering the failure based on an analysis result of the analysis means, and transmission means for transmitting the electronic information generated by the generation means to the monitoring target device.

### SUMMARY OF INVENTION

### Technical Problem

According to the technique disclosed in PTL 1, an order sheet is converted into source codes based on an order sheet in which a system requirement is described, and deployment of resources is automated. By using the technique disclosed in PTL 1, a system can be automatically constructed according to the system requirement even in a case where a user does not have coding knowledge. On the other hand, in a case where an environment assumed by a developer is different from an environment desired to be constructed by the user, the system construction may fail. In this case, it is necessary to clarify the cause of the failure and modify the source codes or the environment desired to be constructed.

Regarding this problem, PTL 2 discloses a technique of acquiring information regarding an error, specifying a cause of an error occurring with reference to a cause table, determining a countermeasure with reference to a countermeasure table, and executing a correction program or the like based on the countermeasure. As a result, even in the construction of the system, the cause can be inferred from the cause table by using, as an input, an error statement or the like when the construction has failed.

The technique of PTL 2 has a problem that man-hours for creating the cause table are required. In addition, it is difficult to infer a cause with high accuracy with respect to an error caused by a difference in environment.

The present invention has been made in view of the above problems, and an object of the present invention is to infer a cause of a construction failure that occurs without requiring man-hours and to be capable of handling the cause, in a case where a user constructs a system.

### Solution to Problem

The representative one of inventions disclosed in this application is outlined as follows. There is provided a cause inference device that estimates a failure cause of construction of a system that constructs infrastructure resource in a predetermined execution environment, the cause inference device comprising: an arithmetic device that executes predetermined arithmetic processing and a storage device connected to the arithmetic device, the cause inference device is configured with a computer including the arithmetic device and the storage device, wherein the cause inference device includes: a cause table creation unit in which the arithmetic device is configured to create a cause table in which an error at the time of construction is recorded in association with the infrastructure resource, a constraint in the construction of the infrastructure resource, and a cause of the error by using construction information of the system and information of an execution environment assumed by the construction information of the system; and a cause inference unit in which the arithmetic device is configured to specify a cause of an error that occurs at the time of constructing the infrastructure resource with reference to the cause table.

### Advantageous Effects of Invention

According to one aspect of the present invention, it is possible to ascertain a cause of a system construction failure that occurs and to quickly handle the cause. Problems, configurations, and effects other than those described above will be clarified by the following description of embodiments for carrying out the invention.

### BRIEF DESCRIPTION OF DRAWINGS

FIG. 1 is a diagram illustrating an example of a configuration of a cause inference device according to Embodiment 1.

FIG. 2 is a diagram illustrating a hardware configuration example of the cause inference device according to Embodiment 1.

FIG. 3 is a flowchart illustrating an example of the operation of the cause table creation unit according to Embodiment 1.

FIG. 4 is a diagram illustrating an example of the constraint list according to Embodiment 1.

FIG. 5 is a diagram illustrating an example of a source code related to deployment processing of the execution environment according to Embodiment 1.

FIG. 6 is a diagram illustrating an example of the cause table according to Embodiment 1.

FIG. 7 is a flowchart illustrating an example of the operation of the cause inference unit according to Embodiment 1.

FIG. 8 is a diagram illustrating an example of a GUI presented in Step S201.

FIG. 9 is a diagram illustrating an example of a GUI presented in Step S205.

FIG. 10 is a flowchart illustrating an example of the operation of the cause inference unit according to Embodiment 2.

FIG. 11 is a diagram illustrating an example of a GUI presented in Step S301.

### DESCRIPTION OF EMBODIMENTS

### Embodiment 1

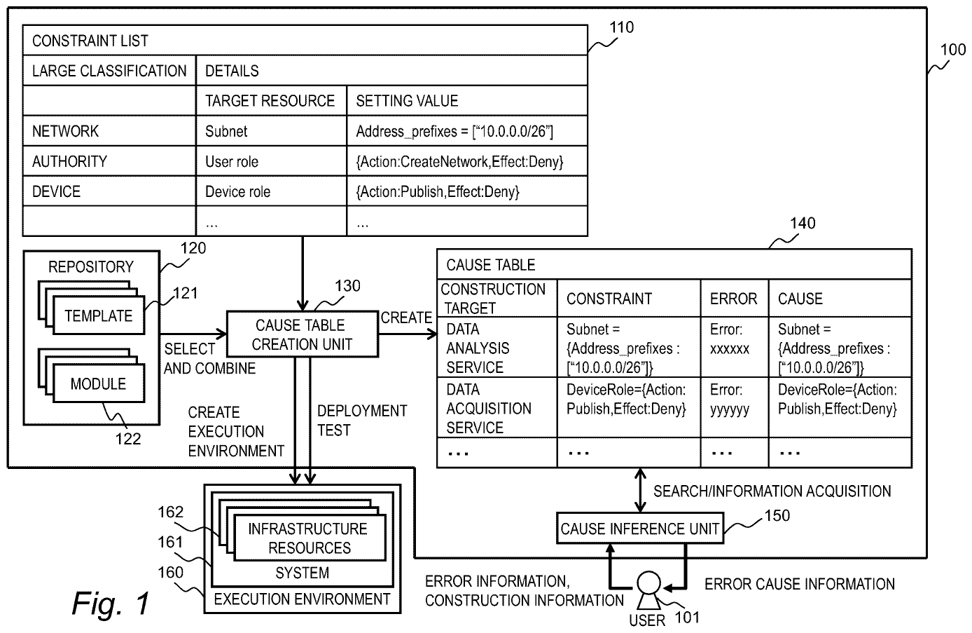

FIG. 1 is a diagram illustrating an example of a configuration of a cause inference device 100 according to Embodiment 1 of the present invention. The cause inference device 100 includes a computer including a constraint list 110, a repository 120, a cause table creation unit 130, a cause table 140, and a cause inference unit 150.

The cause inference device 100 registers source codes of an original template 121 and an original module 122 for deployment in the repository 120 in advance. As the repository 120, for example, a cloud service or a known one provided by OSS can be used. An example of the source codes will be described later with reference to FIG. 5.

Note that FIG. 1 illustrates an example in which a plurality of templates 121 and modules 122 are managed in one repository 120, but the repository 120 may be configured separately for each source code corresponding to a project.

Here, the source code is utilized to construct an execution environment 160 including a specific system 161, a network required by the system 161, or the like. For example, not a configuration in which one system 161 corresponds to one template 121, but a module 122 which is a group of functions constituting a part of the system 161 is also included in the source code. At that time, a plurality of modules 122 are combined to create system source codes of one system 161. Note that, although details will be described later, management information includes various types of information for being managed or displayed by the cause inference device 100, and entities or references of the template 121 and the module 122 which are source codes for constructing the system 161.

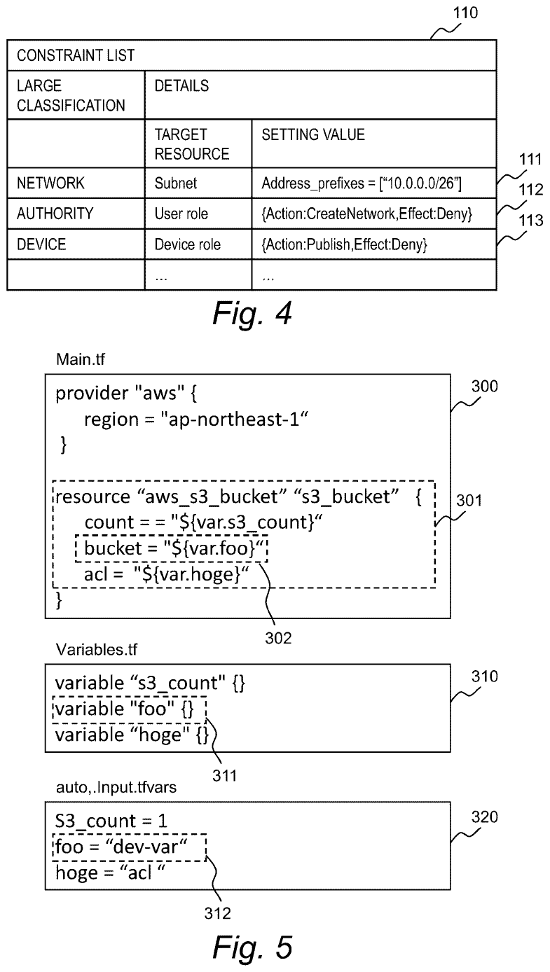

In a case where a user 101 of the cause inference device 100 deploys the template 121 or the module 122 of the repository 120 by using the constraint list 110 or the like, the cause table creation unit 130 creates the cause table 140 by associating the system 161 as a target of deployment, an error at the time of a construction failure that may occur, and a cause of the construction failure. For example, the execution environment 160 to which a constraint defined in the constraint list 110 is given is created, the template 121 and the module 122 of the repository 120 are deployed, and it is confirmed whether an error occurs. In a case where an error has occurred, it is determined that the construction of the template 121 or the module 122 of the repository 120 has failed due to a constraint, and information thereof is added to the cause table 140. An example of specific processing will be described later with reference to FIG. 4.

The user 101 inputs, to the cause inference unit 150, error information when the construction has actually failed and system information as a construction target.

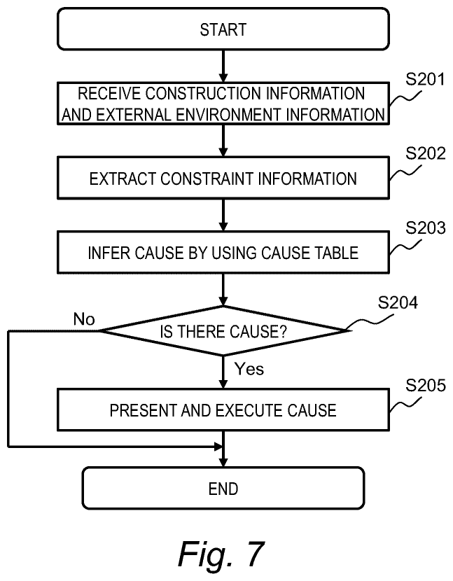

Thereafter, the cause inference unit 150 searches the cause table 140 based on the input information to display and correct the cause of the construction failure. An example of specific processing will be described later with reference to FIG. 7.

The execution environment 160 is an environment for operating the system 161. The execution environment 160 is, for example, a cluster or the like of IT resources managed by an orchestration tool provided by a public cloud service or a private cloud service. Network IT resources required to operate the system 161, a creation authority required to deploy the system 161, certificates for devices associated with the system 161, and the like are also included. The execution environment 160 for operating the system 161 selected by the user 101 may be a format designated by the user 101. At this time, the execution environment 160 may be an execution environment different for each user 101, or one execution environment may be shared.

Note that, the following drawings and description will be given by using an IaaS (Infrastructure as a Service) public cloud of a public cloud service as the execution environment 160, using Terrafrom as deployment processing, and using source codes described in an HCL (HashiCorp Configuration Language) defined in Terraform as the template 121 and the module 131. However, the present embodiment is not limited to the above-described configuration. For example, a combination of Kubernetes as the execution environment 160, a container as a target to be constructed in the execution environment 160, and Helm as the deployment processing may be adopted.

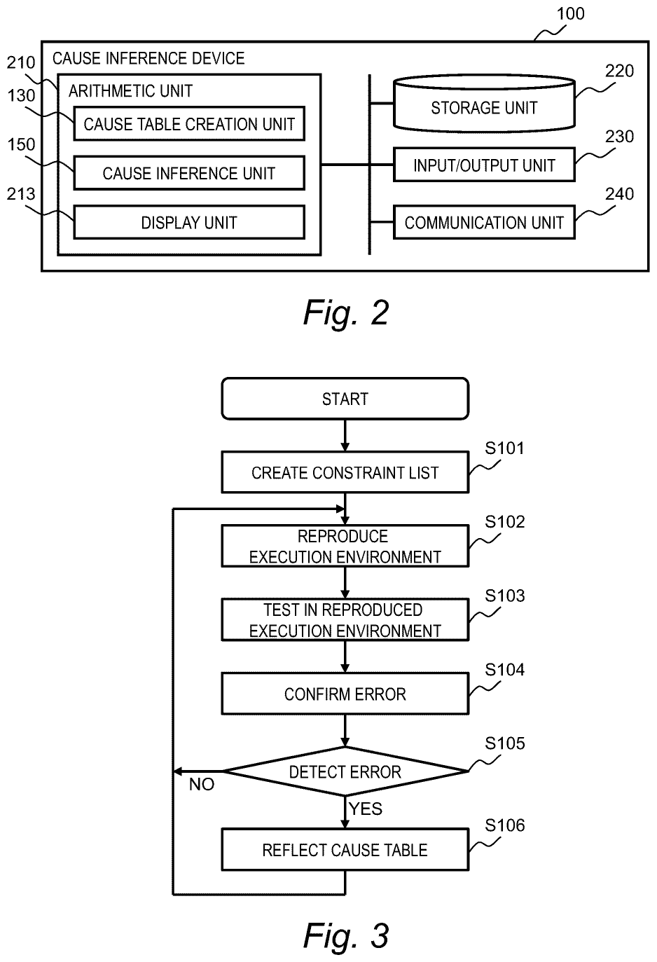

FIG. 2 is a diagram illustrating a hardware configuration example of the cause inference device 100 according to Embodiment 1.

As illustrated in FIG. 2, the cause inference device 100 includes hardware such as an arithmetic unit 210, a storage unit 220, an input/output unit (Interface) 230, and a communication unit 240.

The arithmetic unit 210 includes the cause table creation unit 130, the cause inference unit 150, and a display unit 213. The arithmetic unit 210 and each functional unit included in the arithmetic unit 210 can be configured by hardware such as a circuit device on which these functions are mounted, or can be configured in a manner that an arithmetic device such as a CPU (Central Processing Unit) executes software on which these functions are mounted.

The storage unit 220 includes a storage device that stores data used by the arithmetic unit 210, and includes a ROM that is a nonvolatile storage element and a RAM that is a volatile storage element. The ROM stores an invariable program (for example, BIOS) and the like. The RAM is a high-speed and volatile storage element such as a DRAM (Dynamic Random Access Memory), and temporarily stores a program executed by a processor 1 and data used when the program is executed. Furthermore, the storage unit 220 includes, for example, a large-capacity nonvolatile auxiliary storage device such as a magnetic storage device (HDD) or a flash memory (SSD).

The input/output unit 230 is an interface that receives an input from an operator and outputs a processing result of the arithmetic unit 210 in a form that can be visually recognized by the user, and includes an input device such as a keyboard and a mouse, and an output device such as a display device and a printer. Note that a user terminal connected to the cause inference device 100 via a network may provide the input device and the output device. In this case, the cause inference device 100 may have a function of a web server, and the user terminal may access the cause inference device 100 with a predetermined protocol (for example, http).

The communication unit 240 is a network interface device that controls communication with other devices in accordance with a predetermined protocol, is, for example, a communication chip or a NIC (Network Interface Card), and controls communication with the execution environment 160 and communication with the user 101.

In a case where each unit of the cause inference device 100 receives data, the data may be received via the input/output unit 230 or the data may be received via the communication unit 240.

The program executed by the arithmetic unit 210 is provided to the cause inference device 100 via a removable medium (CD-ROM, flash memory, and the like) or a network and is stored in a nonvolatile auxiliary storage device of the storage unit 220 that is a non-transitory storage medium. Therefore, it is preferable that the cause inference device 100 include an interface that reads data from a removable medium.

The cause inference device 100 is a computer system configured on physically one computer or on a plurality of computers configured logically or physically, and may operate on a virtual computer constructed on a plurality of physical computer resources. For example, a plurality of programs for realizing the functions of the cause inference device 100 may operate on separate physical or logical computers, or may operate on one physical or logical computer in combination of a plurality of programs.

FIG. 3 is a flowchart illustrating an example of the operation of the cause table creation unit 130 according to Embodiment 1. Each step of FIG. 3 will be described below.

### (FIG. 3: Step S101)

The cause table creation unit 130 creates a constraint list 110. The constraint list 110 is obtained by extraction using, as a constraint, a difference between the execution environment 160 assumed by the template 121 or the module 122 of the repository 120 and the execution environment 160 tried to be constructed by the user 101.

FIG. 4 is a diagram illustrating an example of the constraint list 110. The constraint list 110 includes a large classification indicating types of constraints and details indicating details of the constraints. For example, the large classification includes a “network” for constructing the template 121 and the module 122 of the repository 120, an “authority” for construction, a “device” related to the system 161, and the like. The details are specific setting values required for constructing the execution environment 160 which will be described later.

For example, “network Subnet Address_prefixes=[“10.0.0.0/26”]” in a description 111 means that deployment is performed by using the Subnet as a resource and using a setting value Address_prefixes as [“10.0.0.0/26”]. In addition, “authority User role {Action: CreateNetwork, Effect: Deny}” in a description 112 means an authority set when the template 121 or the module 122 of the repository 120 is constructed. Then, “device Device role {Action: Publish, Effect: Deny}” in a description 203 means an authority to permit a device connected to the system 161 to be constructed to operate with respect to the system 161.

A method of creating the constraint list 110 will be exemplified. First, the cause table creation unit 130 acquires information of the execution environment 160 on which the user 101 constructs the system 161. For example, the network IT resources required to operate the system 161 in the execution environment 160 designated by the user 101 may be acquired as the source code by using a function of exporting the network IT resources as the source code of each cloud vendor. In addition, for account information for creation, which is designated by the user 101, the creation authority required to deploy the system 161 may be acquired by using a function of acquiring the authority of each cloud vendor.

Note that, in a case where the information of the execution environment 160 to be constructed cannot be acquired, the information of the execution environment 160 such as a public general reference architecture may be used. For example, in Azure, an example of a system suitable for various purposes is disclosed in the Azure architecture center, and information of a secure network and the like can be acquired as a source code and the execution environment 160 can be constructed. In addition, information of the execution environment 160 used in the past may be used.

After the acquisition of the information, the cause table creation unit 130 compares the information of the execution environment 160 as a target to be constructed, which has been acquired in Step S201, with the execution environment 160 assumed by the template 121 or the module 122 of the repository 120 to acquire the difference. For example, the IT resource related to a network of the assumed execution environment 160 is acquired as a source code by using a function of exporting the IT resource as a source code of each cloud vendor, a portion related to the same network resource is extracted from the source code of the IT resource related to a network of the execution environment 160 as a target to be constructed, which has been acquired in Step S201, by using the source code, and comparison for whether or not the parameters are the same is performed. As a result of the comparison, parameters that are not the same and resources thereof are associated and stored as a difference. In addition, for the assumed account information for creation, the creation authority is acquired for the account information used when the template 121 or the module 122 of the repository 120 is created, by using the function of acquiring the authority of each cloud vendor, and a comparison of whether the authority is included in a creation authority of the execution environment 160 as the target to be constructed, which has been acquired in Step S201, is performed. As a result of the comparison, for the authority that is not included, the creation authority is stored as a difference.

Then, the cause table creation unit 130 adds the difference stored in Step S202 to the constraint list 110. For example, for the difference regarding the network, the network is set for the large classification of the constraint, the detailed resource is set for the target network resource, and the parameter of the target execution environment 160 having the different setting value is set. Furthermore, for the difference regarding the authority, the large classification of the constraint is set to the authority, the detailed resource is set to the authority name, and the setting value is set to the content of the authority.

Although the procedure of automatically creating the constraint list 110 has been described so far, the constraint list 110 is used to simulate the execution environment 160 constructed by the user 101. Thus, the information may be input by the user 101 or may be input from information of the execution environment 160 constructed in the past.

### (FIG. 3: Step S102)

The cause table creation unit 130 selects a constraint from the constraint list 110 and creates the execution environment 160. For example, in the constraint regarding the network, the infrastructure resource 162 regarding the corresponding network is deployed on the execution environment 160 by using the deployment tool to deploy the source code for deploying the detailed resource information based on the detailed setting value. Further, in the constraint regarding the authority, an account to which the corresponding authority has been given is created as an account required when the infrastructure resource 162 is deployed in the execution environment 160, the account is designated, and then the infrastructure resource 162 is deployed in the execution environment 160.

FIG. 5 is a diagram illustrating an example of a source code related to deployment processing of the execution environment 160. The source code and the deployment processing will be described with reference to FIG. 5. Now, a case where Terrafrom is used as the deployment processing will be described. Terraform is an open source automated infrastructure construction tool developed by HashiCorp Inc.

The template information generally includes a source code such as main. tf300 that defines what infrastructure resource 162 is deployed, a variable file in a format such as variables. tf310 in which a variable given to each infrastructure resource 162 and a default value of the variable are defined, and a variable input file in a format such as auto. input. tfvars320 in which a setting value of the variable given to each infrastructure resource 162 is defined.

For example, a description 301 (resource “aws_s3_bucket” “s3_bucket”) means deploying aws_s3_bucket as a resource. In addition, a description 302 (bucket=“${var. foo}”) means that a description 311 (variable “foo” {}) defined in variables. tf310 is read.

Then, if a value is not designated for a variable of the variable key “foo” at the time of the deployment processing, “foo: 1” that is the default value is used. Note that, at the time of the deployment processing, if a value “foo=‘dev-var’” is designated in auto. input. tfvars320 for another value, for example, a variable of the variable key “foo”, the description 311 is generated as “foo: ‘dev-var’”.

Furthermore, the template file may include a programmed element, for example, an if statement. In Terraform, usable programmatic elements are defined, and, with the count variable, how many resources are constructed can be controlled. If the value “S3_count =1” is designated in auto. input. tfvars320, one “resource ‘aws_s3_bucket’ ‘s3_bucket’” is generated.

As described above, network resources may be deployed on the execution environment 160 based on the source code by using the deployment tool. This processing may be generated by refining the existing tool such as Terraform.

Note that a plurality of constraints may be selected from the constraint list 110. In that case, it is desirable to give a constraint regarding the authority first and then give a constraint regarding the network. This is because the authority is related when the execution environment 160 to which the constraint regarding the network is given is deployed.

### (FIG. 3: Step S103)

In Step S103, the cause table creation unit 130 deploys the template 121 and the module 122 of the repository 120 in the created execution environment 160. Then, a test performed on the template 121 or the module 122 of the repository 120 in advance may be executed. In this case, since the test is performed on the template 121 and the module 122 of the same repository 120, it is estimated that the main cause of the failure of the confirmed test is the difference in the execution environment 160.

### (FIG. 3: Step S104)

It is confirmed whether or not an error occurs in the test of Step S103. For example, due to the constraint of the authority, the deployment of the template 121 or the module 122 of the repository 120, which has succeeded, may fail and an error may occur. This is because the assumed authority is insufficient and could not be created. In addition, after the template 121 or the module 122 of the repository 120 is deployed, a communication test that had succeeded in advance may fail. This is because the network constraint of the execution environment 160 prohibits the assumed operation of the network.

### (FIG. 3: Step S105)

In a case where an error is confirmed in Step S104, the cause table creation unit 130 extracts an error content. For example, an error statement when an error has occurred or a test execution result is extracted.

### (FIG. 3: Step S106)

The cause table creation unit 130 stores the error detected in Step S105 in the cause table 140 in association with error information, construction target information such as the template 121 and the module 122 to be constructed, and the constraint. Then, as described in Step S103, a difference caused by giving a constraint mainly from the assumed execution environment 160 is considered as the cause of the failure in deployment or test that has succeeded in the execution environment 160 in advance, and thus, the constraint information is stored in the cause table 140 as the cause.

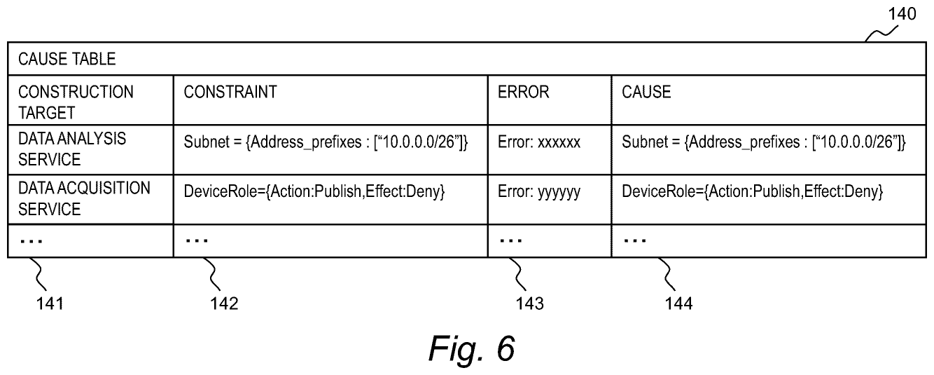

FIG. 6 is a diagram illustrating an example of the cause table 140. The cause table 140 created in Step S106 will be described with reference to FIG. 6.

The cause table 140 has a construction target 401, a constraint 402, an error 403, and a cause 404. The construction target 401 is construction target information such as the template 121 and the module 122 to be constructed, and includes, for example, a name of the construction target, paths of the template 121 and the module 122 to be constructed, and the like. The constraint 402 is a difference from another execution environment 160 in the execution environment 160, and includes, for example, a setting value of the infrastructure resource 162 related to the network and paths of the template 121 and the module 122. Furthermore, authority information representing the authority may be included. The error 403 is error information, and for example, the error 403 includes character information for notifying the occurrence of an error, the outline of error contents, and text information such as an error occurrence place 723. The cause 404 is a cause of the occurrence of an error with respect to the content of the error that has occurred. For example, since a difference in the execution environment 160 due to the constraint 402 is considered to be a cause of the error, the same data is described in the normal constraint 402 and the cause 404.

The cause table 140 does not need to include all the types of above-described information, and each item may also store information in another format.

The description has been given above in which the cause table creation unit 130 reproduces the execution environment 160 that is a deployment target, by the user 101 using the constraint selected from the constraint list 110, tries to deploy the template 121 or the module 122 of the repository 120 whose operation has been confirmed on the reproduced execution environment 160, and adds the cause table 140 due to the difference of the execution environment 160, that is, the constraint when an error has occurred, but the method of specifying the error is not necessarily limited to this method.

For example, an error caused by statically analyzing the template 121 of the repository 120 or the source code of the module 122 may be specified. For example, when the template 121 of the repository 120 or the source code of the module 122 is statically analyzed with respect to the constraint regarding the authority, it is possible to confirm whether the resource related to the authority is included. For example, for the description 202 (“authority User role {Action: CreateNetwork, Effect: Deny}”), a network resource related to CreateNetwork cannot be deployed. Therefore, the source code is lexically analyzed and converted into a token string based on the grammar of the programming language, a tree structure of a conversion result is obtained by converting the converted token string into a tree structure, the resource name is confirmed based on the tree structure, and it is determined whether the resource name related to the network is included. Since it is assumed that the resource related to the network cannot be deployed, it is assumed that the resource related to the network in which this constraint is specified as the cause causes a deployment error, and thus, the resource may be added to the cause table 140. In this case, since the simulation is not performed, the cause table 140 can be quickly created. On the other hand, in the method of reproducing the execution environment 160 described this time, since the test on the infrastructure resource 162 can be performed, there is an advantage that a range that can be confirmed is widened. The processing may be performed by only one method or may be performed by both methods.

In addition, it has been described that the execution environment 160 with a constraint is newly reproduced this time, but the method of reproducing the execution environment 160 is not necessarily limited to this method. For example, in a case where the execution environment 160 deployed by the user 101 can be used by the cause inference device 100, the execution environment 160 may not be newly created. In this case, an attempt is made to deploy the template 121 or the module 122 of the repository 120 with respect to the execution environment 160 designated by the user 101, and when an error has occurred, the cause is added to the cause table 140 due to the difference of the execution environment 160, that is, the constraint. In this case, it is assumed that there are a plurality of constraints, and the plurality of constraints are added to the cause table 140 as causes. In addition, the constraint of the execution environment 160 deployed by the user 101 may be changed. For example, by attempting to deploy the template 121 or the module 122 of the repository 120 after performing the processing of eliminating the constraint of the execution environment 160, the above-described constraint is reduced, and thus, it is easy to specify the cause. In this case, since the time for newly reproducing the execution environment 160 can be shortened, the cause table 140 can be created in a short time. On the other hand, in the method of reproducing the execution environment 160 described this time, by newly reproducing the execution environment 160, a strong authority for directly using the execution environment 160 is unnecessary, and a firm security state can be maintained. In addition, even in a case where another system 161 has already used the execution environment 160, the cause table 140 can be created without affecting the other system 161.

FIG. 7 is a flowchart illustrating an example of the operation of the cause inference unit 150 according to Embodiment 1. Each step of FIG. 7 will be described below.

### (FIG. 7: Step S201)

The cause inference unit 150 receives the construction information and the execution environment information from the user 101. The construction information is information of the system 161 and the infrastructure resource 162 constructed by the user 101. In addition, the execution environment information is information of an external environment such as a network for constructing the system 161 and the infrastructure resource 162, an authority for construction, and a related device. For example, since each cloud vendor prepares metadata indicating that the infrastructure resources 162 have the same purpose as a standard, the infrastructure resources 162 to which the metadata indicating that the execution environment 160 is given can be extracted by using the metadata. Therefore, the metadata may be received as the external environment information.

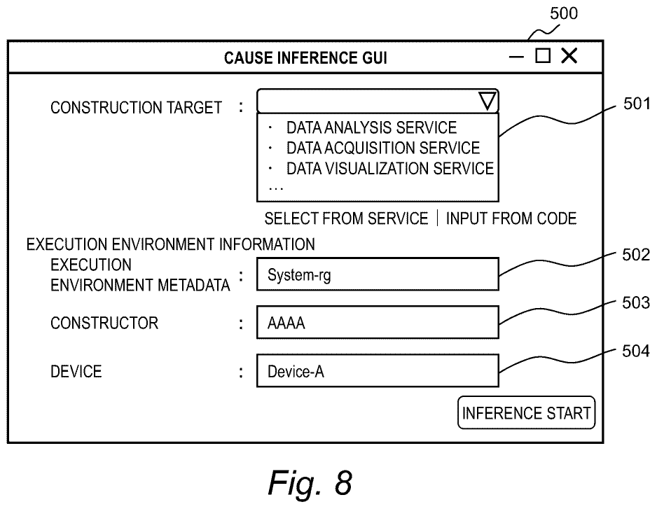

FIG. 8 is a diagram illustrating an example of a GUI presented in Step S201. The display unit 213 displays a cause inference GUI 400 illustrated in FIG. 8. The user 101 inputs the construction information and the execution environment information on the cause inference GUI 400.

In the example illustrated in FIG. 8, options of a data analysis service, a data acquisition service, and a data visualization service are displayed in an item of a construction target 501 as the construction target. The data analysis service, the data acquisition service, and the data visualization service correspond to the infrastructure resources 162 deployed by the template 121 and the module 122 of the repository 120. When the user 101 changes the construction target, the inference result of the cause table 140 which will be described later changes. For example, in a case where the data analysis service is selected, a cause related to the data analysis service is inferred from the cause table 140. The options are examples, and other options may be used. In addition, an input of a source code to be used for deployment may be obtained without displaying an option.

In the example illustrated in FIG. 8, metadata indicating the execution environment is input as the execution environment information in the item of the execution environment metadata 502. When the user 101 changes the execution environment metadata 502, an inference result of the cause table 140 which will be described later changes. For example, the constraint information regarding the network is extracted in Step S202 which will be described later, based on the input metadata. That is, the infrastructure resource 162 related to the network is extracted based on the input metadata. The input method is an example, and an individual input of the infrastructure resource 162 related to the network may be obtained.

Furthermore, in the example illustrated in FIG. 8, information of an account for deploying the infrastructure resource 162 is input in the item of a constructor 503 as the execution environment information. When the user 101 changes the constructor 503, the inference result of the cause table 140 which will be described later changes. For example, the constraint information regarding the authority is extracted in Step S202 which will be described later, based on the input constructor 503. The constraint regarding the authority is extracted based on the input constructor 503. The input method is an example, and may be selected from candidates of the account.

Further, in the example illustrated in FIG. 8, as the execution environment information, a device related to the infrastructure resource 162 is input in the item of the device 504. When the user 101 changes the device 504, the inference result of the cause table 140 which will be described later changes. For example, information of a certificate given to the device is acquired based on the input device 504, and the constraint information regarding the device is extracted in Step S202 which will be described later. The input method is an example, and may be selected from candidates of the device.

The information displayed in FIG. 8 is an example, and may be other types of information.

### (FIG. 7: Step S202)

The cause inference unit 150 extracts a constraint from the information of the execution environment 160 that the user 101 attempts to construct from the construction information received in Step S201. For example, as described in Step S102, the IT resource related to the network of the assumed execution environment 160 is acquired as the source code by using the function of exporting as the source code of each cloud vendor, the portion related to the same network resource is extracted from the source code of the IT resource related to the network of the execution environment 160 to be constructed acquired in Step S201, by using the source code, and whether or not the parameters are the same is compared. As a result of the comparison, a different parameter and a resource thereof are associated and extracted as a constraint. In addition, for the assumed account information for creation, the account information used when the template 121 or the module 122 of the repository 120 is created is acquired by using the function of acquiring the authority of each cloud vendor for the creation authority, and whether the authority is included in the creation authority of the execution environment 160 as the construction target, which has been acquired in Step S201, is compared. As a result of the comparison, for the authority that is not included, the creation authority is extracted as a constraint.

### (FIG. 7: Step S203)

The cause inference unit 150 infers the cause by using the cause table 140. For example, the construction target of the cause table 140 is searched for by using the information of the construction target acquired in Step S201 as a key. In a case where a plurality of rows are searched, the constraint of the cause table 140 is searched by using the constraint acquired in Step S202 as a key. The searched constraint is an error that may cause an error in the cause table 140 included in the specified row. In this case, since the constraint is the cause of the error, a value is returned by combining the error that may occur and the constraint that is the cause. This processing is an example, and for example, in a case where there are a plurality of construction targets, the above-described processing may be executed in units of infrastructure resources, or all of the plurality of specified errors may be returned.

### (FIG. 7: Step S204)

The cause inference unit 150 determines whether the cause has been inferred from the result of Step S204. In a case where the cause is inferred, the processing proceeds to Step S205, and in a case where the cause is not inferred, the processing ends.

### (FIG. 7: Step S205)

In a case where the cause is inferred in Step S204, the cause inference unit 150 presents the specified error and cause to the user 101. As a result, it is possible to ascertain and correct an error caused by a difference in environment.

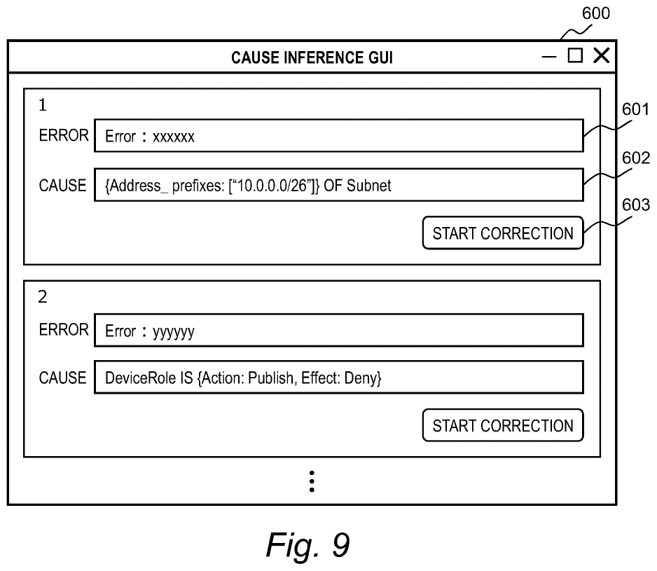

FIG. 9 is a diagram illustrating an example of a GUI presented in Step S205. The display unit 213 displays a cause inference GU 600 illustrated in FIG. 9. The user 101 displays the error and the cause specified on the cause inference GU 600. In FIG. 9, information of the error specified in Step S203 is displayed as an error 601, and the cause of the error specified in Step S203 is displayed as a cause 602. Since it is considered that an error has occurred due to a constraint, when a correction start button 603 is operated, the execution environment 160 of the user 101 is corrected to eliminate the constraint. Note that this requires the user 101 to have the authority to change the execution environment 160, and thus is executed in a case of being permitted by the user 101. In other cases, the user 101 ascertains the constraint as the cause and attempts to correct the constraint. This is because, in the execution environment 160 with strong security, there is a case where the user 101 does not have the authority to change the execution environment 160, and the user 101 alone does not solve the problem, such as making an inquiry to another administrator.

Although the cause table creation unit 130 has been described above to automatically add the cause table 140, the method of adding the cause table 140 is not necessarily automatic addition, and may be created by the user from a past case.

### Embodiment 1: Summary

The cause inference device 100 according to the present Embodiment 1 can clarify a constraint that causes a construction failure by using information of an environment desired to be constructed, create the cause table 140 by associating the system, the constraint, and an error of the construction failure, infer the cause of the construction failure from the cause table 140 in the case of the construction failure, or ascertain the cause of the construction failure that may occur before the construction. Therefore, in a case where the user 101 newly constructs the infrastructure resource 162, the cause inference device 100 can quickly ascertain and correct the error, so that the number of correction steps can be suppressed. In addition, since it is not necessary to create the cause table 140, it is possible to suppress the number of corresponding steps.

### Embodiment 2

Next, Embodiment 2 of the present invention will be described. In Embodiment 2, in a case where the user 101 has failed in the construction, the cause of the error is specified and corrected. As a result, even in a case where the user 101 handles the error, the cause of the error can be quickly identified and corrected with reference to the cause table 140. In Embodiment 2, differences from Embodiment 1 will be mainly described, and the description of the same configuration and processing as those of Embodiment 1 will be omitted.

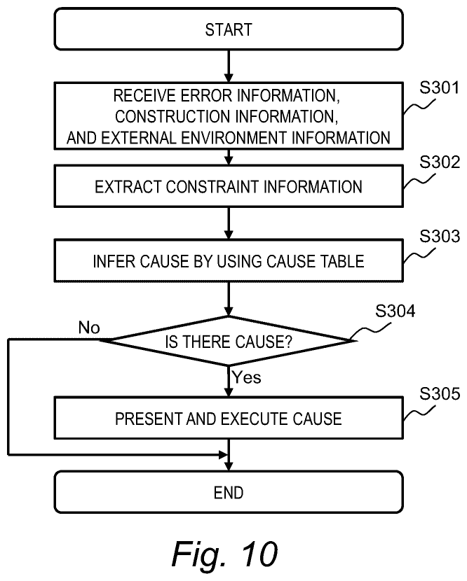

FIG. 10 is a flowchart illustrating an example of the operation of the cause inference unit 150 according to Embodiment 2. Each step of FIG. 10 will be described below.

### (FIG. 10: Step S301)

The cause inference unit 150 receives the construction information, the error information, and the execution environment information from the user 101. The construction information and the execution environment information are the same as those in Embodiment 1. The error information is information related to an error displayed when the user 101 has failed in the construction. For example, it is an error statement representing an error content displayed at the time of the construction failure or an error code thereof.

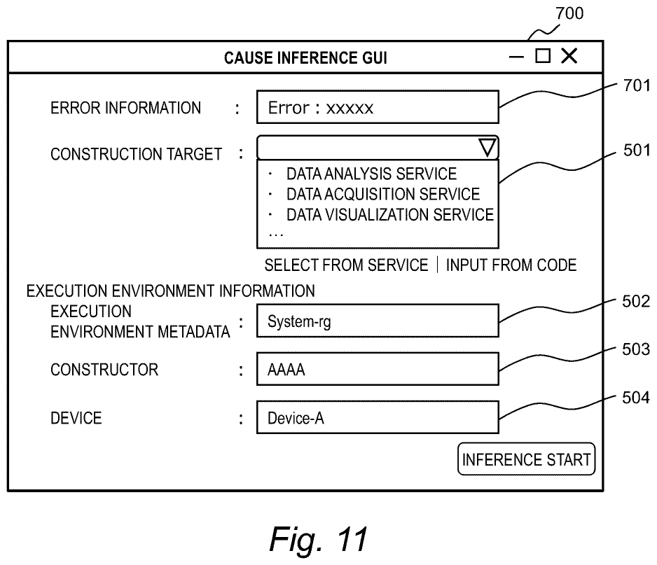

FIG. 11 is a diagram illustrating an example of a GUI presented in Step S301. The display unit 213 displays a cause inference GUI 700 illustrated in FIG. 11. The user 101 inputs construction information, error information, and execution environment information on the cause inference GUI 700.

In the example illustrated in FIG. 11, an example is illustrated in which an error statement displayed at the time of the construction failure in the item of error information 701 is input as the error information. When the user 101 changes the error statement, the inference result of the cause table 140 which will be described later changes. For example, in a case where an error statement is input, a cause related to an error as the target is inferred from the cause table 140. The input method is an example, and an error statement candidate may be selected.

The information displayed in FIG. 8 is an example, and may be other information.

### (FIG. 10: Step S302)

Step S302 is the same as Step S202. In a case where external environment information is not input in Step S301, Step S302 may be skipped.

### (FIG. 10: Step S303)

The cause inference unit 150 infers the cause by using the cause table 140. For example, the error information and the construction information acquired in Step S301 are used as keys to search the construction target of the cause table 140. In a case where a plurality of rows are searched, the constraint of the cause table 140 is searched by using the constraint acquired in Step S302 as a key. The searched constraint is an error that may cause an error in the cause table 140 included in the specified row. In this case, since the constraint is the cause of the error, the constraint that is the cause is returned as a value. This processing is an example, and for example, in a case where there are a plurality of errors and construction targets, the above-described processing may be executed in units of infrastructure resources, or all of the plurality of specified causes may be returned.

### (FIG. 10: Steps S304 and S305)

Steps S304 and S305 are the same as Steps S204 and S205. In Step S304, it is determined whether the value of the cause that is the result of S303 has been returned.

### Embodiment 2: Summary

In Embodiment 2 of the present invention, in a case where the construction has failed, the user 101 can specify the cause of the error and correct the error. As a result, in a case where the user 101 handles the error, the cause of the error can be quickly specified and corrected with reference to the cause table 140.

### Modification Examples of Present Invention

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, an SD card or a DVD.

The drawings illustrate control lines and information lines as considered necessary for explanation but do not illustrate all control lines or information lines in the products. It can be considered that almost of all components are actually interconnected.

1. A cause inference device that estimates a failure cause of construction of a system that constructs infrastructure resource in a predetermined execution environment, the cause inference device comprising:
an arithmetic device that executes predetermined arithmetic processing and
a storage device connected to the arithmetic device,
the cause inference device is configured with a computer including the arithmetic device and the storage device,
wherein the cause inference device includes:
a cause table creation unit in which the arithmetic device is configured to create a cause table in which an error at the time of construction is recorded in association with the infrastructure resource, a constraint in the construction of the infrastructure resource, and a cause of the error by using construction information of the system and information of an execution environment assumed by the construction information of the system; and
a cause inference unit in which the arithmetic device is configured to specify a cause of an error that occurs at the time of constructing the infrastructure resource with reference to the cause table.

2. The cause inference device according to claim 1, wherein the cause table creation unit is configured to create a constraint list based on a result of comparing information of a predetermined execution environment with the information of the execution environment assumed by the construction information of the system.

3. The cause inference device according to claim 2, wherein the cause table creation unit is configured to create the cause table in a manner of performing a simulation for constructing the execution environment by giving a constraint in the constraint list to a source code for constructing the infrastructure resource.

4. The cause inference device according to claim 1, wherein
the cause table creation unit is configured to
create a constraint list based on a result of comparing information of a predetermined execution environment with the information of the execution environment assumed by the construction information of the system, and
statically analyze a source code for constructing the infrastructure resource, and creates the cause table including a place where an error specified by the analysis occurs.

5. The cause inference device according to claim 1, wherein
the cause table creation unit is configured to
specify a place where an error occurs at the time of construction by simulation of the construction using a source code for constructing the infrastructure resource in a predetermined execution environment, and
create the cause table from error statement occurred and information of the execution environment.

6. The cause inference device according to claim 1, wherein
the cause inference unit is configured to
receive infrastructure resource information of a construction target and information of an execution environment of the construction target,
specify a constraint by using the received information as a source code capable of constructing the information of the execution environment and comparing the received information with a source code for constructing an execution environment with no constraint, and
search a record similar to the specified constraint from infrastructure resource information stored in the cause table, and specify a cause of an error having a probability of occurring when the infrastructure resource is created.

7. The cause inference device according to claim 1, wherein
the cause inference unit is configured to
receive an error content at time of construction failure, infrastructure resource information of a construction target, and information of an execution environment of the construction target,
specify a constraint by using the received information as a source code capable of constructing the information of the execution environment and comparing the received information with a source code for constructing an execution environment with no constraint, and
search a record similar to the specified constraint from infrastructure resource information stored in the cause table, and specify a cause of an error having a probability of occurring when the infrastructure resource is created.

8. A cause inference method executed by a computer for estimating a failure cause of construction of a system that constructs infrastructure resource in a predetermined execution environment,
wherein the computer includes an arithmetic device that executes predetermined arithmetic processing and a storage device connected to the arithmetic device, and
the cause inference method comprises:
a cause table creation step creating, by the arithmetic device, a cause table in which an error at the time of construction is recorded in association with the infrastructure resource, a constraint in the construction of the infrastructure resource, and a cause of the error by using construction information of the system and information of an execution environment assumed by the construction information of the system; and
a cause inference step specifying, by the arithmetic device, a cause of an error that occurs at the time of constructing the infrastructure resource with reference to the cause table.
